(19) United States
(12) Patent Application Publication
(10) Pub. No.: US 2009/0031341 A1
(43) Pub. Date: Jan. 29, 2009

(54) METHOD AND APPARATUS FOR REDUCING THE NUMBER OF CONTROL MESSAGES TRANSMITTED BY A SET TOP TERMINAL IN AN SDV SYSTEM

(75) Inventors: John Schlack, Quakertown, PA (US); Fred J. Allegrezza, Hatfield, PA (US); Timothy S. Court, Sellersville, PA (US); Ludwig Cliff Lewis, Jamison, PA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/782,293

(22) Filed: Jul. 24, 2007

(51) Int. Cl. H04N 5/445; H04N 7/173

(52) U.S. Cl. 725/38; 725/118; 725/131

(57) ABSTRACT

A method is provided by which a subscriber accesses an SDV channel using a set top terminal. The method begins when the set top terminal receives a user request to tune to a first SDV channel. An active services list is also received over an access network. The active services list includes an entry for each currently available SDV program and a time-to-live (TTL) associated therewith. Tuning information is identified for the first SDV channel from its entry in the active services list. The set top terminal tunes to the first SDV channel using the identified tuning information. The channel change information associated with the user request is locally stored in set top terminal for transmission over the access network at a later time.

### FIELD OF THE INVENTION

The present invention relates generally to a switched digital video system for distributing content to a subscriber over a system such as a satellite or cable television system, and more particularly to a switched digital video system in which the number of control messages such as channel change messages that are passed between the set top terminal and the on-demand system is reduced.

### BACKGROUND OF THE INVENTION

Switched digital video (SDV) refers to an arrangement in which broadcast channels are only switched onto the network when they are requested by one or more subscribers, thereby allowing system operators to save bandwidth over their distribution network. In conventional cable or satellite broadcast systems, every broadcast channel is always available to all authorized subscribers. In contrast, a switched digital video channel is only available when requested by one or more authorized subscribers. Also, unlike video on-demand, which switches a singlecast interactive program to a user, switched digital video switches broadcast streams, making each stream available to one or more subscribers who simply join the broadcast stream just as they would with normal broadcast services. That is, once a switched service is streamed to a subscriber, subsequent subscribers associated with the same service group as the first subscriber can tune to the same broadcast stream. The switched digital video will often share the same resource managers and underlying resources with other on demand services.

As noted, switched digital video is largely a tool to save bandwidth. From the subscriber perspective, he or she still receives the same broadcast video service when using a switched broadcast technique; ideally the user is not able to discern that the stream was switched at all. If each one of the digital broadcast channels is being watched by subscribers in the same service group, the switched digital video approach does not yield any bandwidth savings. However, a more likely situation statistically is that only a certain number of the digital broadcast channels are being watched by subscribers in the same service group at any given time. Those channels not requested by a subscriber need not be broadcast, thereby saving bandwidth.

One way to support switched digital video is to utilize the session manager to manage SDV and other sessions. For each channel change, the subscriber will set up a broadcast session with the session manager, which will determine if the requested channel is already being sent to the corresponding service group that the subscriber belongs to. The subscriber will be assigned to join the existing SDV session if the requested channel is available at the service group or assigned to a new SDV session if the requested channel is not available at the service group. The session manager will negotiate with the edge devices to allocate resources required for the session. The edge device (e.g., a digital modulator such as a QAM modulator) needs to dynamically retrieve the MPEG single program transport stream that carries the requested SDV program (likely via IP multicast) and generate the MPEG multiple program transport stream. As part of the session setup response message, the video tuning parameters such as frequency and MPEG program number are sent back to the subscriber to access the requested SDV channel.

Communication between the session manager and the subscriber is performed using an SDV Channel Change Message (CCM) protocol, which can be implemented as a proprietary protocol or using an open standard. Among other things, these protocols pass channel change requests from the subscriber to the session manager. The session manager responds by sending a message that includes the necessary tuning information to the subscriber. However, these protocols generate a large number of messages, which can consume a large amount of bandwidth, particularly when there are a relatively large number of subscribers requesting channel changes.

### BRIEF DESCRIPTION OF THE DRAWINGS

FIG. 1 shows one example of a system architecture for delivering switched digital video content to a subscriber.

FIG. 2 shows one example of the headend depicted in FIG. 1.

FIG. 3 shows the logical architecture of one particular example of a set top terminal.

FIG. 4 shows one example of the hardware employed in the set top terminal of FIG. 3.

FIG. 5 shows one example of a method by which a subscriber accesses an SDV channel using a set top terminal.

### DETAILED DESCRIPTION

As detailed below, the number of channel change messages that need to be sent from a subscriber to the SDV manager or other appropriate entity is reduced by accumulating a history or log of channel changes that have been previously performed by the subscriber. In addition, the subscriber can access an SDV channel without sending a request to the SDV manager. This can be accomplished with the use of the active services list that is repeatedly transmitted to the subscriber terminals.

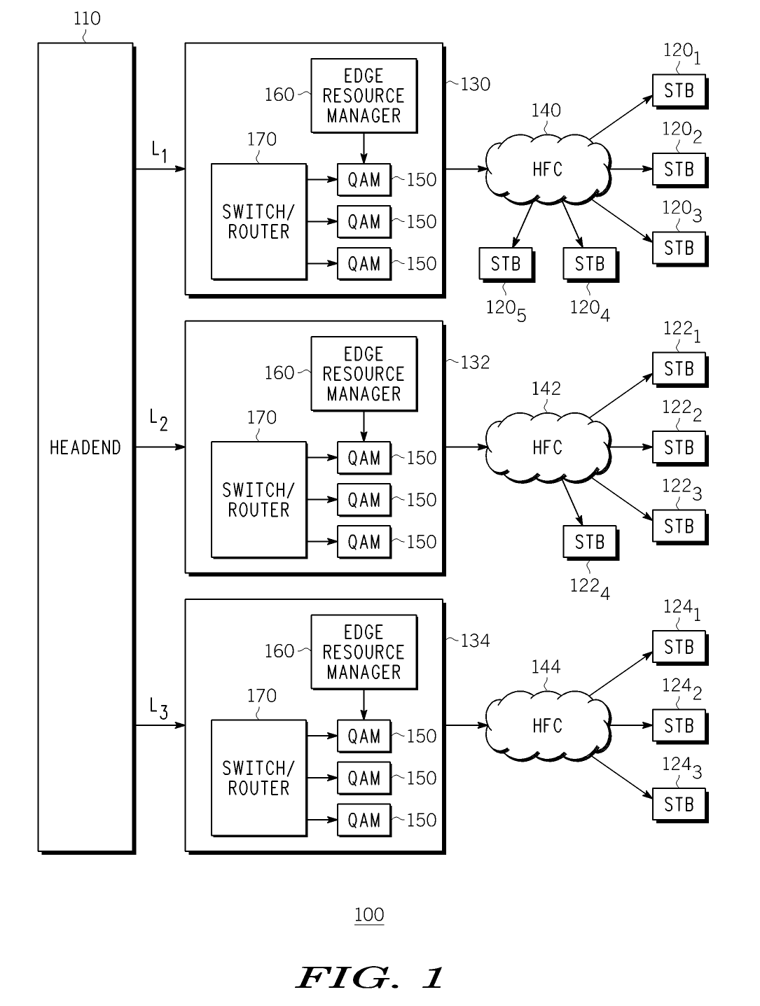

FIG. 1 is a system architecture 100 for delivering switched digital channels to a subscriber during a switched digital video (SDV) session. The SDV session is implemented through a service offering in which application level data generated by a set-top terminal initiates a SDV session request and an SDV manager routes data in accordance with the request to provision the service. Among other components, system architecture 100 comprises a content source such as a headend 110 that is connected to multiple intermediate entities such as hubs 130, 132 and 134. The headend 110 communicates with a switch or router 170 in hubs 130, 132 and 134 over links L1, L2 and L3, respectively. The headend 110 and hubs 130, 132, and 134 may communicate over a packet-switched network such as a cable data network, passive optical network (PON) or the like using, for example, IP multicast addressing.

Some or even all of the hubs are connected to multiple users, typically via distribution networks such as local cable access networks (e.g., HFC networks). For simplicity of explanation only, each hub is shown as being connected to a distinct HFC network, which in turn communicates with end user equipment as illustrated. In particular hubs 130, 132 and 134 in FIG. 1 communicate with access networks 140, 142 and 144, respectively. Each access network 140, 142 and 144 in turn communicates with multiple end user devices such as set top or subscriber terminals. In the example of FIG. 1, access network 140 communicates with set top terminals 120₁, 120₂, 120₃, 120₄ and 120₅, access network 142 communicates with set top terminals 122₁, 122₂, 122₃ and 124₄, and access network 144 communicates with set top terminals 124₁, 124₂ and 124₃.

In addition to the switch or router 170, each hub can include an array of radio frequency transmitter edge devices such as edge QAM modulators 150. The number of edge devices 150 in each hub may vary as needs dictate. As used herein, the term “QAM” refers to modulation schemes used for sending signals over cable access networks. Such modulation schemes might use any constellation level (e.g. QAM-16, QAM-64, QAM-256 etc.) depending on the details of a cable access network. A QAM may also refer to a physical channel modulated according to such schemes. Typically, a single QAM modulator can output a multiplex of ten or twelve programs, although the actual number will be dictated by a number of factors, including the communication standard that is employed. The edge QAM modulators usually are adapted to: (i) receive Ethernet frames that encapsulate the transport packets, (ii) de-capsulate these frames and remove network jitter, and (iii) transmit radio frequency signals representative of the transport stream packets to end users, over the HFC network. Each transport stream is mapped to a downstream QAM channel. Each QAM channel has a carrier frequency that differs from the carrier frequency of the other channels. The transport streams are mapped according to a channel plan designed by the MSO that operates the network.

Each hub 130, 132 and 134 also includes an edge resource manager 160 for allocating and managing the resources of the edge devices 150. The edge resource manager 160 communicates with and receives instructions from the session manager located in the headend 110. In some case the edge resource manager and/or session manager can be located in the headend.

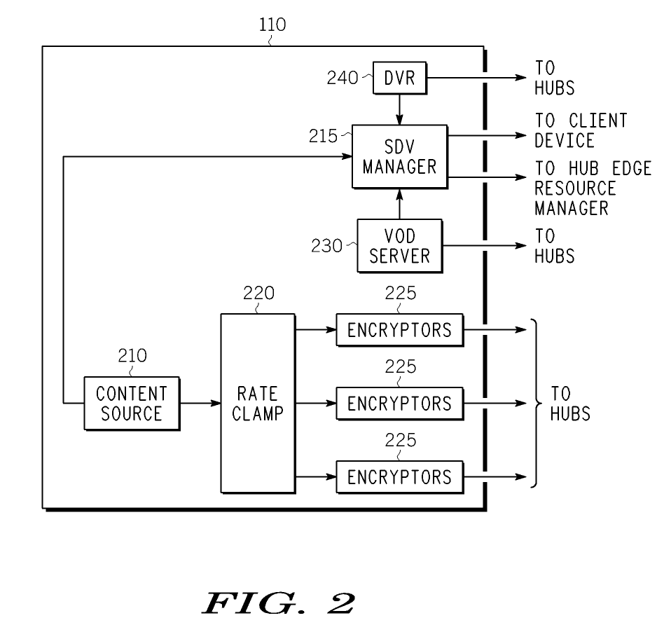

FIG. 2 shows one example of headend 110. The headend 110 includes a broadcast content source 210, which may include, by way of example, satellite receivers, off-air receivers and/or content storage devices such as servers. A SDV manager 215 is used to determine which SDV transport streams are being transmitted at any time and for directing the set top terminals to the appropriate stream. The SDV manager 215 also keeps track of which subscribers are watching which channels and it communicates with the edge resource managers 160 in the hubs so that the content can be switched on and off under the control of the SDV manager 215. In addition, all subscriber requests for a switched digital channel go through the SDV manager 215. The switched digital channels are forwarded to a rate clamp 220 and one or more encryptors 225 using, for example, IP multicast addressing. The content is then encrypted by the encryptors 225 and transmitted to the appropriate hub or hubs. Typically, standard definition (SD) channels are currently rate clamped to 3.75 Mbps while high definition channels are currently rate clamped to between about 12 Mbps and 15 Mbps. The encryptors 225 encrypt the digitally encoded content, often under the control of a conditional access system (not shown).

Headend 110 may also include a network DVR 240. The network DVR 240 stores content that can be transmitted to a set top terminal via a hub and access network in response to a user request to play a program stored on the DVR 240. Other user input requests are also serviced by network DVR 240, including, for example, requests to accelerate the playing of a program in the forward direction (e.g., cueing) and in the reverse direction (e.g., reviewing). The content is stored by the network DVR 240 upon a user request. The content may be provided to the network DVR 240 from any available content source, including, for example, content source 210.

Headend 110 may also include a variety of other components for offering additional services. For example, in FIG. 2 a video on demand (VOD) server 230 is shown for storing programs or other content for distribution to subscribers on an on-demand basis. Although not shown, one of ordinary skill in the art would recognize that other components and arrangements for achieving the various functionalities of headend 110 are possible. For example, the head-end 110 may comprise typical head-end components and services including a billing module, an advertising insertion module, a subscriber management system (SMS), a conditional access system and a LAN(s) for placing the various components in data communication with one another. It will also be appreciated that the headend configuration depicted in FIG. 2 is a high-level, conceptual architecture and that each network may have multiple head-ends deployed using different architectures.

The edges devices 150 provide programming to the set top terminals using the downstream in-band channels. To communicate control information and the like with the headend 110 and/or the relevant hub, the set top terminals may use out-of-band (OOB) or DOCSIS channels or an IP tunnel or an IP connection and associated protocols. However, in some cases communication of control information and the like can be performed using in-band channels as well.

Control information that may be communicated over the out-of-band channels includes the aforementioned SDV channel change messages (CCM), which are used to pass channel change requests from the subscriber to the SDV manager 215 in the headend 110. In particular, the SDV manager 215 receives channel change requests for switched digital content from a set top terminal to bind that content to a session on one of edge devices 150 serving that set top terminal's service group. The channel change request message is generated by the SDV application (or its designated proxy) resident in the set top terminal in response to the subscriber's program channel request that is entered by the set top terminal's user interface. The SDV manager 215 responds to the set top terminal with the frequency and program number where that content may be found. The SDV manager 215 also receives channel change request messages for non-SDV (e.g., broadcast) channels in order to gather statistics that can be used to better understand subscriber activity and to provide information that can be used for targeted advertising and the like. Another reason to receive non-SDV channel changes is so that the SDV Manager knows when the set top terminals are no longer tuned to an SDV channel, thus allowing the SDV Manager to remove the SDV channel from the network to save bandwidth.

Reductions in the number of channel change messages that are sent from the set top terminal to the SDV manager 215 can be achieved both when the subscriber is changing from one broadcast channel to another, as well as when the subscriber is requesting an SDV channel on the active services list or changing from one SDV channel to another SDV channel on the active services list. In the case when the subscriber is first tuning to a broadcast channel or switching from one broadcast channel to another, the channel change information can be queued or accumulated in the set top terminal and sent at a substantially later time after some predetermined number of channel changes have been performed or after a predetermined amount of time has elapsed (e.g., 5-60 minutes). Alternatively, the accumulated channel change information can be sent whenever there is sufficient bandwidth available. In this way channel change information relating to broadcast channels need not be transmitted each and every time the subscriber makes such a channel change, thereby reducing the number of individual messages that need to be transmitted. Despite this reduction, the SDV manager 215 can still gather all the statistical information concerning subscriber activity that is obtained when a separate message is transmitted for each channel change.

If an SDV channel is not on the active services list, then a channel change message needs to be send in order for the subscriber to view the SDV programming.

Channel change messages can also be reduced not only when the subscriber is requesting a broadcast channel, but also when requesting an SDV channel. This can be accomplished by using the information that is repeatedly sent from the SDV manager to the set top terminals, which contains a list of all the active services currently streaming to each service group along with the tuning parameters required to access them. This repeating information is typically transmitted either in-band or out-of-band using a protocol such as the mini-carousel protocol (MCP). For example, in the case of the mini-carousel protocol, the MCP message sent to the set top terminals includes one entry for each active service (e.g., each SDV program). An illustrative format of the entry is as follows: (i) Bytes 0-3: Broadcast Program ID; (ii) Byte 4: Modulation Index (6=QAM-16, 7=QAM-32, 8=QAM-64, 12=QAM-128, 16=QAM-256); (iii) Bytes 5-7: Carrier Center Frequency/100; (iv) Bytes 8-9: MPEG Program Number; (v) TTL—Bytes 10-11 indicating the number of seconds for which the entry is valid. Of course, other protocols may be used instead of the MCP described above. One piece of information that is available in the entry for each service is the Time-To-Live (TTL), which specifies the expected remaining duration of an active service. For instance, the TTL may specify that a particular SDV channel will be available for, say, another 30 minutes.

Instead of transmitting a channel change messages when a subscriber requests an SDV program, the subscriber's set top terminal can use the information in the active service list to tune to the desired channel, assuming of course that the channel is included in the active service list. Assuming that the channel is in fact present in the list, the set top terminal can send the channel change information for the SDV program at a later time, similar to the case mentioned above when a broadcast channel is requested. However, a Channel Change Message will need to be sent shortly before (e.g., 15-30 seconds) expiration of the TTL for the requested SDV program. In this way the SDV manager can extend the TTL to ensure that the SDV program will continue to be available for the subscriber. When the TTL is extended, the SDV program can be made available on either the same or a different channel number and frequency, which information can be communicated to the set top terminal when the SDV manager responds to the channel change message.

The set top terminal can even change from one SDV channel to another SDV channel without sending a channel change message by using the information in the active service list in the manner described above, provided of course that the TTL for the variously selected SDV programs do not expire. In this case the set top terminal can accumulate a history SDV channel changes that can be subsequently transmitted to the SDV manager in a single message.

In some cases additional bandwidth savings can be achieved by ensuring that the channel change message sent by the set top terminal fits within a single packet. Previously, such messages often occupied multiple packets. For instance, in one particular example the packet payload size is limited to 34 bytes, whereas the channel change message requires 36 or more bytes. Various techniques may be employed to reduce the channel change message so that it will fit within the available 34 bytes of a single packet. For instance, unused space can be removed from the messages. The unused space may have been provided for byte alignment purpose or to reserve space for future use. Reducing the message to a single packet conserves both upstream bandwidth (because only one packet sent instead of two) and downstream bandwidth (because only one acknowledgment needs to be sent, instead of the multiple acknowledgements that are needed for multiple packets).

When a set top terminal includes two or more tuners, additional bandwidth savings can be achieved by sending only one message when two would have otherwise been sent. For instance, tuner usage messages are transmitted from the set top terminal to the SDV manager whenever the status of a tuner changes, such as when a tuner is used to record a program, when a tuner terminates a recording session, or when the tuner is used to acquire a Video-on-Demand (VOD) program. If a set top terminal includes two or more tuners, the status of each tuner can be transmitted in a single message instead of sending a different message for each tuner. For instance, a situation can arise in which a set top terminal having two tuners, one of which is being used as the foreground terminal and the other is being used as the background terminal (e.g., for PIP), swap their respective roles. Conventionally, each tuner would send its own status message indicating its change in status from foreground to background, and visa versa. Instead, however, a single tuner usage message can be transmitted simply indicating that the roles of each of the two tuners have been interchanged.

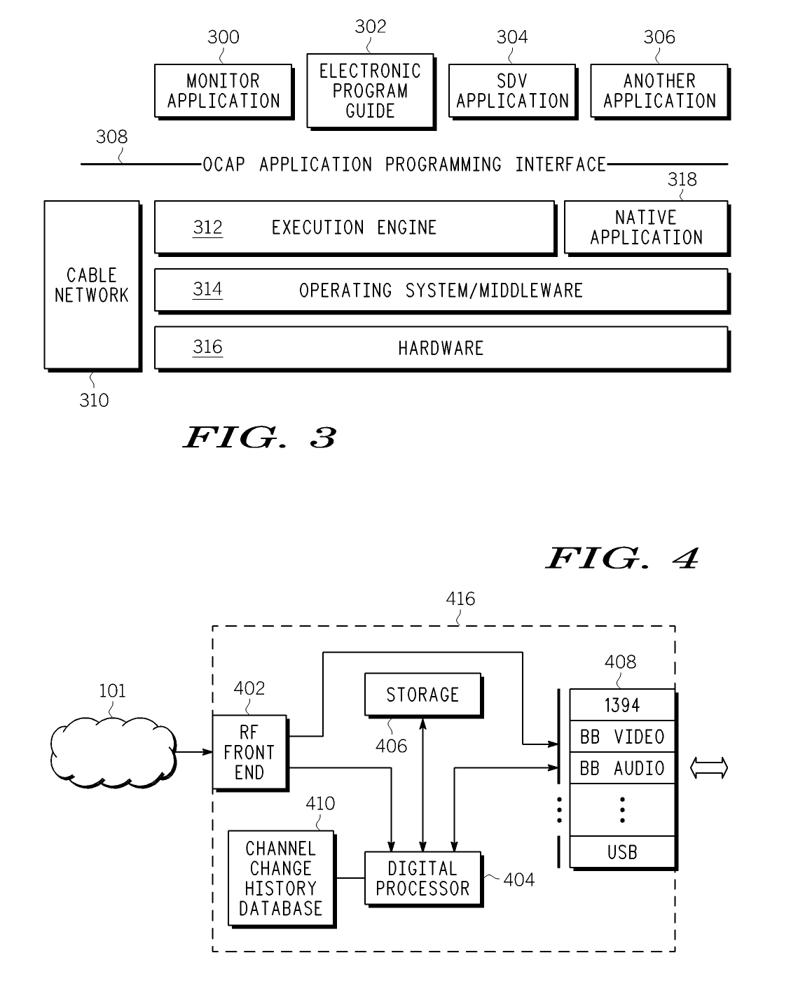

FIG. 3 shows the logical architecture of one particular example of a set top terminal. In this example the set-top terminal is compliant with the OpenCable Application Platform (OCAP) hardware and software environment. The OCAP specification is a middleware software layer specification intended to enable the developers of interactive television services and applications to design such products so that they will run successfully on any cable television system, independent of set-top or television receiver hardware or operating system software choices. As is well known, middleware generally comprises one or more layers of software which are positioned “between” application programs and the lower or physical layers of the network device. Middleware is commonly written for the specific requirements of the operator of the computer system, and the proprietary software purchased by the operator of the computer system. A key role of middleware is to insulate the application programs from the device specific details. By using middleware the application programmers need know very little about the actual network details, since they can rely on the middleware to address the complexities of interfacing with the network. Of course, the set top terminal is not limited to an OCAP-compliant software/hardware architecture. In other cases, for example, the client devices 106 may be compliant with MHEG, DASE or Multimedia Home Platform (MHP) middleware. Alternatively, the set top terminal may be based on a proprietary architecture.

Referring to FIG. 3, the top of an OCAP software “stack” includes a Monitor Application 300, Electronic Program Guide (EPG) 302, SDV 304, and any other applications 306 that may be deployed in a particular network. These applications are run on top of a software layer called the “Execution Engine” 312 and interface to the Execution Engine using the well known OCAP APIs 308. The client device may also include certain software applications or “Native Applications” 318 that do not run within the Execution Engine, but directly run on top of the Operating System/Middleware 314 for the client device. Native Applications are typically written for, e.g., a particular hardware configuration 316 of the client device 106. Examples of such Native Applications may include management of front panel functionality, remote control interaction, games, and the like. The objects downloaded to the client device in accordance with the techniques described herein may include any of the aforementioned applications and programs as well as additional applications, programs or other objects. However, during an upgrade many of the objects that need to downloaded may be directed to applications located above the OCAP application programming interface 308.

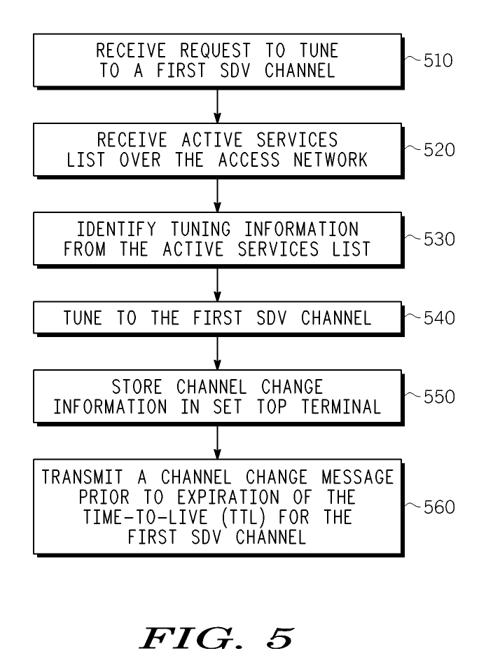

FIG. 4 shows one example of the set top terminal hardware 416. The device hardware 416 generally includes an RF front end 402 (including a modulator/demodulator and a tuner or tuners) for interfacing with the distribution network (e.g., HFC network 140) of FIG. 1, digital processor(s) 404, storage device 406, and a plurality of interfaces 408 (e.g., video/audio interfaces, IEEE-1394 “Firewire”, USB, serial/parallel ports, etc.) for establishing communication with other end-user devices such as televisions, personal electronics, computers, WiFi or other network hubs/routers, etc. Other components which may be utilized within the device include one or more decoder stages, various processing layers (e.g., DOCSIS MAC, OOB channels, MPEG, etc.) as well as media processors and other specialized SoC or ASIC devices. These additional components and functionality are well known to those of ordinary skill in the art and accordingly are not described further herein.

The SDV application 304 is responsible for communicating SDV control messages (e.g., CCMs) between the set top terminal and the SDV manager. For this purpose the set top terminal hardware 416 includes a channel change history database 410 in which the accumulated channel change information can be stored until it is ready to be transmitted to the SDV manager.

FIG. 5 shows one example of a method by which a subscriber accesses an SDV channel using a set top terminal. The method begins in step 510 when the set top terminal receives via its user interface a user request to tune to a first SDV channel. Next, in step 520, the set top terminal receives an active services list over an access network. The active services list, which may be received before or after receipt of the user request, includes an entry for each currently available SDV program and a time-to-live (TTL) associated therewith. The set top terminal uses the active services list in step 530 to identify tuning information for the first SDV channel that has been requested by the user. In step 540 the set top terminal tunes to the first SDV channel using the identified tuning information. The channel change information associated with the user request is stored by the set top terminal in step 550 for subsequent transmission over the access network. The channel change information is transmitted in a channel change message in step 560 prior to expiration of the TTL for the first SDV channel. In this way the subscriber can continue to view the first SDV channel even after it would have otherwise been terminated.

The processes described above, including but not limited to those presented in connection with FIG. 5, may be implemented in general, multi-purpose or single purpose processors. Such a processor will execute instructions, either at the assembly, compiled or machine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

Although various examples are specifically illustrated and described herein, it will be appreciated that modifications and variations thereof are covered by the above teachings and are within the purview of the appended claims without departing from the spirit and intended scope of the invention. For example, it should be noted that in some cases some or all of the functionality of the SDV manager 215 may be transferred to each of the hubs 130, 132 and 134. For example, as described below, channel change messages may be communicated between the set top terminals and the hubs.

1. At least one computer-readable medium encoded with instructions which, when executed by a processor, performs a method comprising:
receiving a user request to tune to a first SDV channel;
receiving an active services list over an access network, the active services list including an entry for each currently available SDV program and a time-to-live (TTL) associated therewith;
identifying tuning information for the first SDV channel from its entry in the active services list;
tuning to the first SDV channel using the identified tuning information; and
locally storing first channel change information associated with the user request for transmission over the access network at a later time.

2. The computer-readable medium of claim 1 wherein the first channel change information is transmitted over the access network in a channel change message prior to expiration of the TTL for the first SDV channel.

3. The computer-readable medium of claim 2 wherein, in response to transmission of the channel change message, receiving an updated active services list in which the TTL of the first SDV channel has been extended.

4. The computer-readable medium of claim 1 wherein the active services list is received over an in-band channel using a mini-carousel protocol and the first channel change information is transmitted over the access network on an out-of-band channel.

5. The computer-readable medium of claim 1 further comprising:
receiving a second user request to switch from the first SDV channel to a second non-SDV channel;
tuning to the second non-SDV channel;
locally storing second channel change information associated with the second user request for transmission over the access network at the later time;
transmitting the first and second channel change information over the access network at the later time in a single channel change message.

6. The computer-readable medium of claim 1 further comprising:
locally storing additional channel change information associated with a user request to switch from one non-SDV channel to another non-SDV channel;
transmitting the first, second and additional channel change information over the access network in a single channel change message when a prescribed number of channel change requests have been received.

7. The computer-readable medium of claim 1 wherein the first channel change information fits into a payload of a single transport packet transmitted over the access network.

8. The computer-readable medium of claim 1 wherein the user request specifies use of a first tuner to tune to the first SDV channel, wherein the first tuner is selected from among at least two available tuners, and wherein the channel change information is transmitted in a single channel change message that includes status information pertaining to both available tuners.

9. A set top terminal, comprising:
an RF front-end for receiving programming content over an access network;
a processor operatively associated with the RF front-end;
a storage medium operatively associated with the processor;
a user interface; and
wherein, responsive to channel change requests received via the user interface, the processor is configured to tune to various SDV channels by identifying tuning information for the various SDV channels, the tuning information being located in an active services list received by the RF front-end over the access network.

10. The set top terminal of claim 9 wherein the processor is further configured to store in the storage medium first channel change information associated with a first user request and to cause transmission of the first channel change information over the access network at a substantially later time.

11. The set top terminal of claim 10 wherein the processor is further configured to cause transmission of the first channel change information in a channel change message prior to expiration of a time-to-live (TTL) for the first SDV channel.

12. The set top terminal of claim 10 wherein the processor is further configured to store in the storage medium additional channel change information associated with additional user requests to tune to additional channels and to cause transmission at the later time of the first and the additional channel change information in a single channel change message.

13. The set top terminal of claim 9 wherein the RF front-end is configured to receive the active services list over an in-band channel in accordance with a mini-carousel protocol and to transmit the first channel change information over the access network on an out-of-band channel.

14. The set top terminal of claim 11 wherein the first channel change information fits into a payload of a single transport packet transmitted over the access network.

15. The set top terminal of claim 10 wherein the RF front-end includes a plurality of tuners and wherein the processor is further configured to cause transmission of the first channel change information in a single channel change message that includes status information pertaining to the plurality of tuners.

16. A switched digital video (SDV) system, comprising:
an SDV manager for coordinating SDV sessions requested by subscriber terminals associated with a service group;
an input for receiving content to be broadcast during the SDV sessions;
at least one edge device for receiving transport streams that include SDV programming provided by the input and for transmitting each transport stream over an access network to at least one of the subscriber terminals on one of a plurality of SDV channels; and
wherein the SDV manager is configured to receive channel change messages from subscriber terminals that each include information pertaining to a plurality channel changes performed by the respective subscriber terminals.

17. The switched digital video (SDV) system of claim 16 wherein the channel change message fits into a payload of a single transport packet transmitted over the access network.

18. The switched digital video (SDV) system of claim 16 wherein the channel change message includes status information pertaining to a plurality of tuners.
